(19) United States
(12) Patent Application Publication
(10) Pub. No.: US 2026/0151966 A1
(43) Pub. Date: Jun. 4, 2026

(54) METHOD AND DEVICE FOR THE MANUFACTURE OF A PAIR OF SPECTACLES FROM AT LEAST ONE LENS

(71) Applicant: FTA, Le Cres (FR)

(72) Inventors: Michel HODZAJ, Le Cres (FR); Paul-Eric ROBERT, Le Cres (FR); Philippe MARTINEZ, Le Cres (FR)

(21) Appl. No.: 18/706,391

(22) PCT Filed: Nov. 18, 2022
(86) PCT No.: PCT/EP2022/082514

§ 371 Date: May 1, 2024

(30) Foreign Application Priority Data
Nov. 18, 2021 (FR) FR2112212

(51) Int. Cl. B29C 64/393; B29L 12/00; B33Y 50/02; B33Y 80/00

(52) U.S. Cl. CPC B29C 64/393; B33Y 50/02; B33Y 80/00; B29L 2012/005

(57) ABSTRACT

The method for manufacturing a frame of a pair of spectacles from at least one lens to be inserted therein, in a manner that said frame is adapted to the shape and dimensions of the lenses, comprises:
a step of scanning to obtain a representation, in at least two dimensions, of a contour of at least one lens by means of a file comprising information representative of the contour,
a step of computing a frame of a pair of spectacles on the basis of the representation of the contour of each lens and
a step of controlling a machine for manufacturing the computed frame.

### TECHNICAL FIELD OF THE INVENTION

This invention concerns a method and a device for the manufacture of a pair of spectacles from at least one lens. The present invention applies particularly to the field of eyewear.

### STATE OF THE ART

Usually, when a spectacle frame is damaged and can no longer be worn by a person with poor eyesight, it must be repaired or replaced. This operation requires a time ranging from several hours (for a repair) to several days (for a total or partial replacement) depending on the organisational constraints of the optician, its suppliers and manufacturers of frames, including, in a non-limiting way, their workloads, their lead and delivery times, the repair time at the manufacturer or optician.

In most cases, the wearer of damaged spectacles makes a makeshift repair with glue or adhesive tape, or by fitting a temple of “uncoupled” frames on the damaged frame. In addition to the unsightly appearance of this makeshift repair, it frequently does not restore optimum vision. And it must be repeated several times because the glue or adhesive tape get fouled or does not hold the broken parts of the frame correctly.

During the time of the optician's intervention, the wearer has the choice between no longer wearing spectacles at all if his eyesight allows him to do this, or to wear old spectacles or replacement spectacles poorly adapted to his eyesight and/or poorly adapted to other characteristics linked to the wearer or the original spectacles.

Thus there is discomfort for the wearer and, potentially, a risk of visual health, or even accident, if he has to drive a vehicle or control a machine, without spectacles or with ill-adapted spectacles.

Document WO0188654A2 presents an invention that envisions an adjustment of spectacles, via a computer. An image of a person with poor eyesight wearing spectacles is taken by a camera linked to a computer, and the computer sends this image over a network to the optician. By measuring this image, the optician can produce lenses adapted to the wearer's frame and a frame adapted to the wearer.

Document U.S. Pat. No. 6,682,195B2 describes a device for automatically collecting anthropometric data relating to the wearer's head in order to produce customised frames adapted to the wearer.

Document WO2016176630A1 describes a system for the customised design of a spectacle frame adapted to the morphology of the wearer, which system consists of intervening manually on a pre-existing computerised 3D model to modify the size of 3D components of the frame with respect to measurements made on the wearer's face by means of a camera.

Other documents, such as US2021247630A1 or WO2019020521, also only teach of the adaptation of a spectacle frame to the wearer's head, nor do they address the problem that is the basis for the invention.

Documents https://content.instructables.com/pdfs/ECC/4JXU/HVFL5XAX/3d-scanning-a-glasses-lens.pdf and https://content.instructables.com/pdfs//EVO/3ZCV/HVFL5WQ0/how-to-design-3d-printed-glasses.pdf are known, which present a computer design method comprising a series of automatic or manual steps generating cumulative inaccuracies, in particular inaccuracies arising from the optical scan step, mesh cleaning step, and manual contour tracing step.

### PRESENTATION OF THE INVENTION

The present invention aims to remedy all or part of these drawbacks.

To this end, according to a first aspect, the present invention envisions a device for manufacturing a frame of a pair of spectacles from at least one lens to be inserted therein, such that said frame is adapted to the shape and dimensions of the lenses, which device comprises:
a scanner configured to represent, in at least two dimensions, a contour of at least one lens and supply a file comprising information representative of this contour;
a means for computing the frame suitable for receiving and holding each lens, on the basis of the representation of each lens contour; and
a means for controlling a machine for manufacturing the computed frame.

Thanks to these provisions, from a single spectacle lens the optician equipped with the device that is the subject of the invention can manufacture a frame suitable for receiving and holding in position the lenses of a damaged pair of spectacles.

The present invention thus has the advantage of significantly shortening the time-scale for providing a new frame offering the benefit of being sufficiently durable compared to gluing, adhesive tapes and other makeshift repairs. The new frame is adapted to the characteristics of the lenses and dimensions of the original frame, temporarily replacing this damaged frame.

In this way, the present invention gives the optician control over the time-scales for providing a frame independent of the organisational constraints mentioned above. In addition, the present invention has the advantage of keeping the optical axes of the lenses intact, as in the original frame. Note that the lenses associated with the original frame must be useable. The device relies solely on one or two lenses and one or more additional items of data supplied by the optician, in particular the distance between the lenses.

In some embodiments, the device also comprises a machine for manufacture by additive printing of successive layers, the printing material being a flexible material and the computing means being configured to control the manufacturing machine such that the entire surface of the frame surrounding the lenses is printed as of the first printed layer.

Thanks to these provisions, the manufacture can be less costly and no modification to the rims surrounding the lenses is needed, the flexibility of the material making up these rims ensuring the deformation capacity of the frame so that it adapts to the lenses of the pair of spectacles.

In some embodiments, the computing means is configured to ensure compliance with a predefined criterion among:
the curvature of each rim surrounding a lens intended to go into this rim and in a plane tangential to the lens, and comprising an axis parallel to the optical axis of this lens;
the radial cross-section of each rim, in a plane perpendicular to this plane tangential to the lens and comprising an axis parallel to the optical axis of the lens; and
the elasticity limit of the printing material.

Thanks to these provisions, the radial cross-section of each rim can be adjusted to the lens, whose contour dictates the flexing of the rims according to the curvature indicated above and the elasticity limit of the material used.

In some embodiments, the computing means is configured to define each rim as a function of the curvature of each lens intended to go into this rim and in a plane tangential to the lens, and comprising an axis parallel to the optical axis of this lens.

Thanks to these provisions, the perimeter of the rim, once deformed to surround the lens, corresponds to the non-planar perimeter of the lens.

In some embodiments, the computing means is configured to estimate this curvature of the lens based on a shape factor of the lens and a curved shape of the lens.

Thanks to these provisions, although the contour of the lens is represented in two dimensions by the scanner, the difference between the perimeter of the contour represented and the perimeter of the actual contour can be estimated and taken into account in the definition of each rim of the frame.

In some embodiments, the scanner is configured to represent, in two dimensions, the contour of each lens and supply a file comprising information representative of this contour in two dimensions.

In some embodiments, the scanner is configured to represent the contour of a counter-bevel formed on the contour of the lens, and the computing means is configured to:
make a deduction for a portion of an estimate of the difference between this contour of the counter-bevel and the contour of the lens outside this counter-bevel,
define rims with a bezel corresponding to this counter-bevel.

Thanks to these provisions, the counter-bevels can fit in the bezels of the rims of the frame.

In some embodiments, the device comprises the additive layer manufacturing machine, the computing means being configured such that the bezel is formed uniformly in the same successive layers for the whole of the rim of the frame surrounding this lens.

In some embodiments, the computing means is configured to form a counter-bevel turned towards the lens in at least one rim of the frame.

Thanks to these provisions, the frame simulates the presence of a wire, for example Nylon (registered trademark), for a lens designed to be retained by such a wire.

In some embodiments, the computing means is configured to produce two different rims for lenses with different contours.

Thanks to these provisions, reclaimed lenses can form another frame, for example for the provision, by non-governmental organisations, of pairs of spectacles for poor people in developing countries.

In some embodiments, the computing means is configured to form a rim around each lens, with one portion taken away from the contour of the lens at the bridge between the lenses, this bridge thus having two side pieces on each lens.

Thanks to these provisions, additional flexibility can be created to help to insert lenses in the frame.

In some embodiments:
the 3D printer uses a bio-based, biodegradable and/or recyclable material for printing;
the device comprises a slicer between the control means and the manufacturing machine;
the manufacturing machine uses a rigid material, the scanner provides a three-dimensional representation of at least one lens;
the scanner is configured to represent, in at least two dimensions, a contour of a lens, at least one direction of which is referenced, and the computing means is configured to receive a measurement of the distance between the lenses, determine the shape of a second lens of the pair of spectacles by symmetry with the lens scanned, and provide the control means with a representation of the two lenses separated by the distance measured;
the computing means is configured to determine the rims surrounding the lenses incorporating bezels corresponding to the counter-bevels of the lens and a bridge shape between the rims;
the computing means is configured to determine an end piece shape for supporting a temple hinge and shapes of temples to be attached to the hinges of the end pieces; and/or
the computing means is configured to determine the colour or distribution of colours of the frame.

According to a second aspect, the present invention relates to a method for manufacturing a frame of a pair of spectacles from at least one lens to be inserted therein, in a manner that said frame is adapted to the shape and dimensions of the lenses, which method comprises:
a step of scanning to obtain a representation, in at least two dimensions, of a contour of at least one lens by means of a file comprising information representative of the contour;
a step of computing the frame of a pair of spectacles on the basis of the representation of the contour of each lens; and
a step of controlling a machine for manufacturing the computed frame.

As the features, advantages and aims of this method are similar to those of the equipment that is the subject of the invention, they are not repeated here.

### BRIEF DESCRIPTION OF THE FIGURES

Other advantages, aims and features of the present invention will become apparent from the description that will follow, made, as a non-limiting example, with reference to the drawings included in an appendix, in which:

FIG. 1 represents, schematically, a particular embodiment of a device that is the subject of the invention;

FIG. 2 represents a spectacle lens, viewed perpendicular to its optical axis;

FIG. 3 represents a frame of a pair of spectacles suitable for receiving and keeping in position the lens illustrated in FIG. 2;

FIG. 4 represents, in the form of a logic diagram, steps in a particular embodiment of the method that is the subject of the invention;

FIG. 5 represents, in the form of a logic diagram, steps in computing a frame of a pair of spectacles on the basis of the representation of at least one lens; and

FIG. 6 represents a radial circular cross-section of a lens frame.

### DESCRIPTION OF THE EMBODIMENTS

The present description is given in a non-limiting way, in which each characteristic of an embodiment can be combined with any other characteristic of any other embodiment in an advantageous way.

Note that the figures are not to scale.

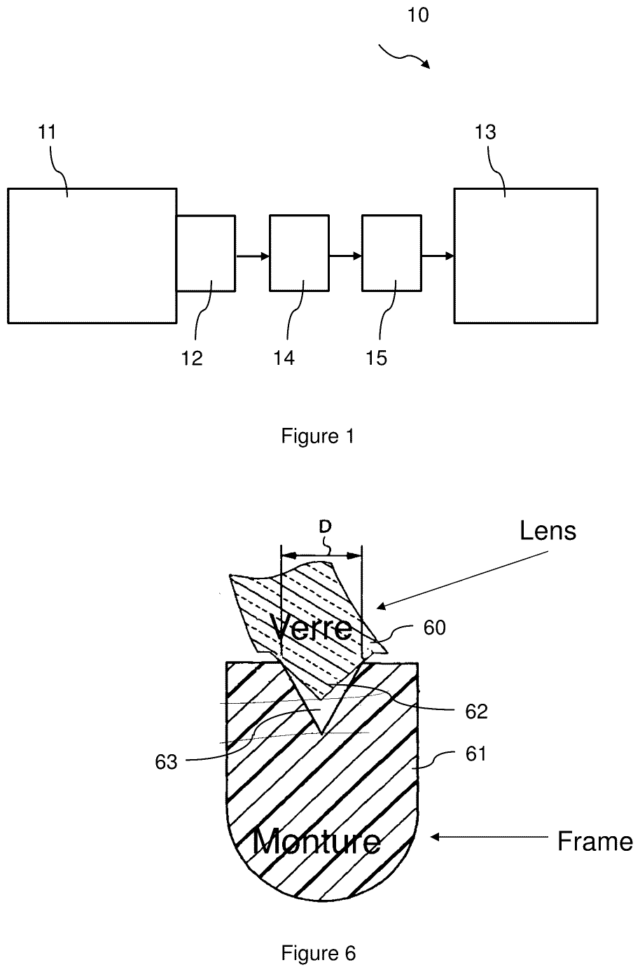

FIG. 1 shows a device 10 for manufacturing a frame of a pair of spectacles from at least one lens to be inserted therein, which device comprises:
a scanner 11 configured to represent, in at least two dimensions, a contour of at least one lens and supply a file comprising information representative of this contour;
a means 12 for computing the frame of a pair of spectacles suitable for receiving and holding each lens, on the basis of the representation of each lens contour;
a step 14 of controlling a machine 13 for manufacturing the computed frame; and
possibly, a slicer 15.

In the preferred case where the manufacturing machine 13 is a 3D printer, the device 10 prints a frame of a pair of customised eyeglasses adapted to the shape of the lenses.

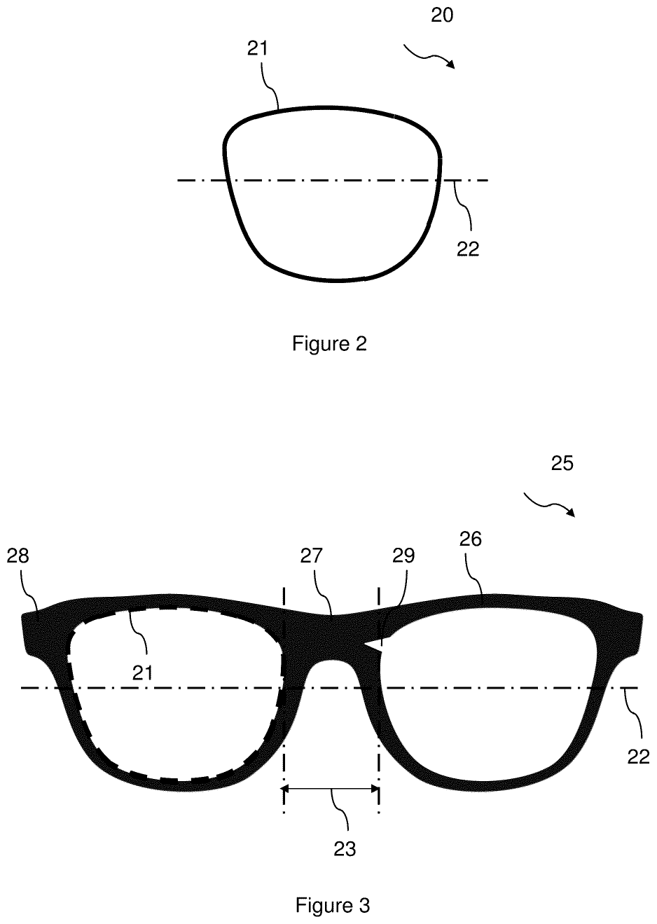

The scanner 11 is of a known type. The scanner 11 determines the shape of the contour of the lens 20 shown in FIG. 2 and records it in a file with a standardised format. Regular calibration of the scanner 11 makes it possible to obtain precise dimensions. A tracing arm rotating in at least two dimensions moves to follow each curve of the contour 21 of the lens 20. To ensure the correct orientation of the lens, the optician traces the horizontal axis 22 on the lens 20 with an erasable marker when the lens 20 is placed in the old frame. Next, the optician positions the lens 20 in the scanner 11, matching the horizontal axis 22 with a reference horizontal axis of the scanner 11. In this way, the horizontal axis 22 of the lens 20 is referenced and orients the digitisation so that the file with the representation of the contour 21 of the lens 20 takes it into account. It is noted that, when the optician inserts the lens into the scanner-tracer, he enters into the latter's user interface whether it is a right lens or a left lens. It is noted that the representation of the contour 21 of the lens 20 follows the contour of the counter-bevel, this counter-bevel being a standardised prismatic extension over the entire contour of the lens. For example, the radial cross-section of this counter-bevel is a triangle. By means of this counter-bevel, the lens is adjusted to the frame that comprises a bezel geometrically corresponding to this counter-bevel.

The optician also determines the distance 23 between the lens, either by making a measurement on the old frame, or by reading this distance on a temple of the old frame.

The manufacturing machine 13 can use different materials, either in a subtractive way, for example by grinding down wood or a plastic material, or in an additive way, for example with a 3D printer with a laser for curing material or a printing nozzle with a plastic material. In an embodiment in which the manufacturing machine is a 3D printer, the material is preferably PLA (acronym for Polylactic acid, a plastic material of plant origin) or ABS (acronym for acrylonitrile butadiene styrene, a thermoplastic polymer) for reasons of flexibility. Preferably, the 3D printer uses a bio-based, biodegradable and/or recyclable material for printing.

The computing means 12 is preferably the programmable computer incorporated into the scanner 11. The control means 14 is a programmable computer system, for example a calculator, computer or a server accessible online. In some variants, the computing means 12 and the control means 14 are combined in a single computer system, possibly incorporated into the scanner 11.

The slicer 15 is adapted to the case where the control means 14 generates an “stl” file representing the 3D frame. The slicer 15 retrieves this stl file to carry out the slicing and generate a “g-code” file which it sends to the manufacturing machine 13.

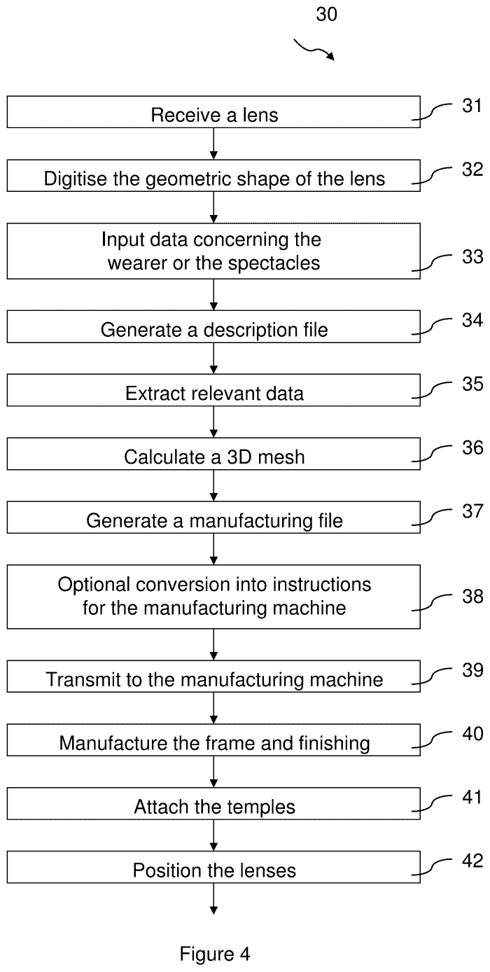

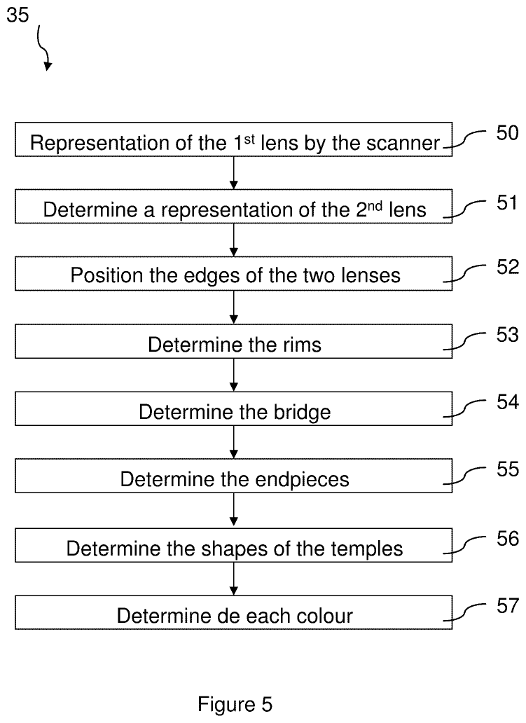

The computing means 12 and the control means 14 jointly carry out the steps shown in FIG. 5. The slicer 15 carries out the step 38 shown in FIG. 4.

During a step 50, the scanner determines a representation in at least two dimensions of the contour of the first lens and, possibly, the second lens, if it has a different shape from the first lens.

During a step 51, the computing means 12 of the scanner 11 determines and stores the representation of the second lens if only a single lens was scanned. This representation of the second lens is the symmetric of the representation of the single lens scanned relative to an axis perpendicular to the horizontal axis of the lens.

During a step 52, the computing means 12 positions the representations of the contours of the two lenses in the memory of the computer 14 such that their distance corresponds to the distance of the lenses in the old frame and that their horizontal axes are common. For example, it records this scan in “Oma” or “xml” format on the hard disk of the computer 14.

During a step 53, the computer 14 determines the rims 26 surrounding the lenses incorporating the bezels corresponding to the counter-bevels of the lenses. These rims can have a variable thickness over the contour of the lens, based on the aesthetic choice of the user or optician, especially if he wants the new frame to resemble the damaged original frame as closely as possible.

During a step 54, the computer 14 determines a shape of the bridge 27 between the rims. This bridge shape can be constant for all the frames to be manufactured or can depend on the type of the old frame and/or the age of the wearer of the spectacles. For example, the optician enters an indication of whether the old frame was metal or plastic, whether the frame was semi-circular. Therefore, the bridge of the future frame can vary according to the type of the original frame. For example, a “key nose” bridge is preferably used a distance between lenses of at least 21 mm. Similarly for children, whose nose does not have the same curvature as the nose of an adult, the bridge, positioned more in the middle of the height of the lenses 20 than for an adult, compensates for the difference in morphology. Of course, an aesthetic choice of the wearer can also be taken into account.

During a step 55, the computer 14 determines an end piece shape 28 for supporting each hinge. The shape of this end piece is aesthetically consistent with the shape of the bridge. This shape preferably comprises a recess forming a housing for a fixed portion of the hinge, for example a standardised metal hinge. Alternatively, this fixed portion of the hinge is incorporated into the end piece and comprises at least one vertical through-opening to receive a rotating shaft for the portion of the hinge incorporated into a temple or carried by a temple. It is noted that the width of the temple (width measured in the horizontal direction in FIG. 3) corresponds to the distance between the rim and the hinge. This distance is standardised in a preferred mode. However, it can be slightly modifiable to handle aesthetic adjustments. It is noted that the positions of the hinges preferably correspond to an angle between the deployed temples and the inclination plane of the lenses of about 8 degrees.

During a step 56, the computer 14 determines the shapes of the temples aesthetically consistent with the bridge, end pieces and rims, and, possibly, with an aesthetic choice. In a variant, the temples are standardised or are not manufactured by the manufacturing machine. In that case, step 56 is not performed.

Optionally, during a step 57, the computer 14 determines the colour or distribution of colours of the frame, for example based on a colour indication of the old frame or on aesthetic choices made by the wearer.

The frame 25 to be manufactured is therefore completely designed in the memory of the computer 14, in three dimensions, at the end of step 57.

Of course, depending on the embodiments, the order of the steps of the method 35 can vary. Similarly, with regard to the production of clip-on sunglasses, the determinations of the end pieces, hinges and temples will be replaced by a determination of the portion of the frame intended to receive the mechanism for positioning the clip on a frame.

Note that, for frames to be manufactured with a flexible material, the curved shape of the frame is given by the lenses. In effect, the optician heats the manufactured frame slightly to enable the lenses to be clipped in. It is in this step that the frame receives the curved shape because, on being heated, it becomes more flexible and takes the shape of the curved shape of the lens. In some variants, the bridge and/or the rims are determined to favour a curved shape of about 4° between the mid-planes of the lenses.

In the case where the manufacturing machine 13 uses a rigid material, for example wood, metal or a rigid plastic material, the scanner 11 makes a three-dimensional representation of the end of the counter-bevel of at least one lens 20. The shape of the lens 20 is therefore supplied by the scanner 11 in the form of a representation in three dimensions.

Other details of embodiments of the device that is the subject of the invention are given below.

In what follows, the scanner-tracer 11 is an appliance known to the expert, used for carrying out a 2D or 3D topographical survey of an object submitted to it. The scanner-tracer used here operates either with an optical or mechanical scanner, or any other method having the same purpose.

One particular embodiment of the method 30 that is the subject of the invention consists of several steps occurring in the following chronological order:
step 31: the optician receives a spectacle frame, referred to as the “old” frame, and the lenses of this frame; he traces the horizontal axis on at least one lens fitted in the old frame;
step 32: the optician positions a lens in the scanner, positioning the horizontal axis of the lens parallel to a predefined horizontal axis of the scanner;
step 33: the optician inputs data concerning the spectacles into a user interface of a calculation software program; these data comprise, in particular, the distance between the lenses and, possibly, other data indicated with regard to FIG. 5;
step 34: the scanner then digitises in at least two dimensions the geometric shape of the contour of the lens, and produces a representation of this contour, for example in polar coordinates; the scanner-tracer generates and records on any type of medium (removable, remote computer by means of a wired or wireless connection, electronic card, removable or not, electronic card associated with a frame production tool via a wired or wireless link, etc.) a file containing all the topographic data of the lens collected by the tracer; This file, coming from the tracer, can be in the form (non-limiting) of a DCS (acronym for “Data Communications Standard”) file, having for example a suffix “.oma”, “.xml”, used by the global consortium “The Vision Council”;
step 35: a software program comprising an algorithm for automatically generating a 3D model based on relevant data of the file of topographic data; for example, step 35 comprises steps 51 to 57 shown in FIG. 5;
step 36: a software program constructs a mesh to be used by the manufacturing machine;
step 37: this same software program generates a 3D model description file that can be used by manufacturing machines (a non-limiting example of which is an “.stl” file);
step 38: depending on the method of manufacture used, an intermediate software program, called the “slicer”, between the above-mentioned software program and the manufacturing method can receive the file generated in step 37 to convert it into manufacturing fabrication specific to the machine employed;
step 39: the manufacturing file, generated depending on the case in step 37 or 38, is sent to the control means by any communication means (wireless or wired, recording on a removable electronic or memory device connected directly to the computer) to the manufacturing machine;
step 40: the manufacturing machine reads the file received and uses the description of the 3D model it contains to physically manufacture the frame generated virtually in step 35. This manufacturing machine can use for this any material conversion method available to it. In a non-limiting way, this material conversion method can be 3D printing, plastic injection, CNC (acronym for “Computer Numerical Control”) machining, laser engraving, etc. This machine can use any material, for example plastic, metal, wood. Possibly, the optician carries out a step of finishing the surface of the frame, for example trimming, or heat or chemical treatment improving the polished appearance of the frame;
step 41: The optician attaches the temples. These temples have already been manufactured beforehand by any method whatsoever, or are manufactured by the manufacturing machine used in step 40 or a similar machine;
step 42: the optician positions the lenses in the frame and gives the pair of spectacles back to the wearer.

The frame generated by this method is therefore customised to the lenses of the wearer, the characteristics specific to the wearer and to the frame to be repaired or replaced, because it matches the dimensions of its lenses and the data entered by the optician.

In some embodiments, the computing means estimates or measures a difference between the actual perimeter of the lens at the extremity or bottom of its counter-bevel, in three dimensions because of its curvature, and the perimeter in two dimensions represented by the data supplied by the scanner. In effect, when the scanner supplies data only representing the contour of a lens in one plane, this induces a first difference between these perimeters.

Alternatively or additionally, in some embodiments the computing means estimates or measures a difference between the actual perimeter of the contour of the lens at the extremity or bottom of its counter-bevel, in three dimensions because of its curvature, and the perimeter of a print in two dimensions, i.e. a print in which the front surface of the future frame being printed is tangential to the plane on which the additive printing is carried out, the first printing layers comprising the whole of this front surface.

In effect, when the printing is made in two dimensions, this induces a second difference. Each of the first and second differences can cause the frame to break when it is mounted onto the lens.

In these embodiments, the computing means estimates or measures the actual perimeter based on:
the curvature of the contour of the counter-bevel of the lens, measured in a plane tangential to this contour and comprising the optical axis of the lens, which curvature can be estimated based on the average curved shape of the lens, comprised between four degrees and six degrees, or based on the curved shape measured by an operator;
the shape factor of the lens, the ratio of the largest and smallest dimensions of the contour of the lens.

This difference is then used by the computing means to increase the perimeter of the rim of the frame to be printed. This increase can be an addition of the difference or a multiplication by the ratio of the perimeters, these two adjustment methods ensuring a correspondence between the perimeter of the printed rim and the actual perimeter of the lens.

In some embodiments, the device also comprises an additive layer manufacturing machine, the printing material being a flexible material and the computing means being configured such that the entire surface of the frame surrounding the lenses is printed as of the first printed layer. Consequently, the manufacture can be less costly and no modification to the rims surrounding the lenses is needed, the flexibility of the material making up these rims ensuring the deformation capacity of the frame so that it adapts to the lenses of the pair of spectacles. In other terms, although the lens is in three dimensions, not in one plane, which means that the frame, once mounted onto the lens, will have a non-planar shape, in these embodiments the frame rims are printed in two dimensions as of the first print layer by addition of material. The successive layers produce a flat frame tangential to the layer on which the printing is performed by the deposition of material.

This therefore avoids having to deal with the imperfections of a three-dimensional print on a flat support, which requires temporary supports to be printed under the relevant printed portion that corresponds to the final frame.

Preferably, the computing means is configured to ensure compliance with a predefined criterion among:
the curvature of each rim surrounding a lens intended to go into this rim and in a plane tangential to the lens, and comprising an axis parallel to the optical axis of this lens;
the radial cross-section of each rim, i.e. in a plane perpendicular to this plane tangential to the lens and comprising an axis parallel to the optical axis of the lens; and
the elasticity limit before breakage of the printing material.

This predefined criterion defines combinations that are impossible between this curvature, radial cross-section and the elasticity limit before breakage. Thus, although the frame must be deformed to adapt to the lenses, the computing means anticipates the geometric characteristics of the printed frame and reduces the risks of breakage, while allowing choices, for example aesthetic, in the definition of this frame. Therefore, the radial cross-section of each rim of the frame is, in these embodiments, adjusted to the lens, whose contour dictates the flexing of the rims according to the curvature indicated above and the elasticity limit without breakage of the material used.

Preferably, the computing means is configured to define each rim as a function of the curvature of each lens intended to go into this rim and in a plane tangential to the lens, and comprising an axis parallel to the optical axis of this lens. In this way, the perimeter of the rim, once deformed to surround the lens, corresponds to the non-planar perimeter of the lens, to which a tolerance is added, for example fixed or proportional to this perimeter.

In some embodiments, the computing means is configured to estimate this curvature of the lens based on a shape factor of the lens and a curved shape of the lens. Thanks to these provisions, although the contour of the lens is represented in two dimensions by the scanner, the difference between the perimeter of the contour represented and the perimeter of the actual contour can be estimated and taken into account in the definition of each rim of the frame. The shape factor is minimal when the lens has a perfectly circular contour, and maximal when the largest dimension of the contour of the lens to its smallest dimension is maximal, for example in the case of a rectangular lens where the ratio of the large side to the small side is maximal. The higher the factor and curved shape of the lens, shown in degrees, the higher the ratio of the actual perimeter of the lens to the perimeter of the contour represented in two dimensions. These embodiments anticipate this difference and this ratio, and thus reduce the risks of the frame breaking when mounting the frame onto the lens.

Preferably, the scanner is configured to represent, in two dimensions, the contour of each lens and supply a file comprising information representative of this contour in two dimensions.

Preferably, the scanner is configured to represent the contour of a counter-bevel formed on the contour of the lens, and the computing means is configured to:
make a deduction for a portion of an estimate of the difference between this contour of the counter-bevel and the contour of the lens outside this counter-bevel,
define rims with a bezel corresponding to this counter-bevel.

Therefore, the counter-bevels can fit in the bezels of the rims of the frame.

Preferably, the device comprises the additive layer manufacturing machine, the computing means being configured such that the bezel is formed uniformly in the same successive layers for the whole of the rim of the frame surrounding this lens. Therefore, the counter-bevel of the lens is at the same distance from the front surface of the frame, once the frame is mounted onto the lens.

Preferably, the computing means is configured to form a counter-bevel turned towards the lens in at least one rim of the frame. Thus, the frame simulates the presence of a wire, for example Nylon (registered trademark), for a lens designed to be retained by such a wire.

Preferably, the computing means is configured to produce two different rims for lenses with different contours. Therefore, reclaimed lenses can form another frame, for example for the provision, by non-governmental organisations, of pairs of spectacles for poor people in developing countries.

Preferably, the computing means is configured to form a rim around each lens, with one portion 29 (see FIG. 3, for the right rim) taken away from the contour of the lens at the bridge 27 between the lenses 21, this bridge 27 thus having two side pieces on each lens (in FIG. 3, on a single lens, for educational purposes). Thus, additional flexibility can be created to help to insert lenses 21 in the frame 25.

All the variants below follow the method described above.

In a first variant, step 31 is performed using a damaged frame instead of the lenses.

In a second variant, step 31 is performed using the two lenses of the frame.

In a third variant, steps 33 and 34 are reversed: the optician inputs data concerning the wearer or the spectacles into the software program of the scanner-tracer after the scanner-tracer has measured the lenses.

In a fourth variant, steps 31, 32, 33 and 34 use a software and/or hardware device made available to the wearer. This device has the functions useful for the present invention that are also present in the optician's scanner-tracer: topographic measurements of one or both spectacle lenses, recording these measurements in a file, and a means for the outward transfer of this file.

In a fifth variant, steps 31, 32, 33 and 34 lead to a file of topographic data that can be used by a software program converting these data into the required format for a cutting machine, for example, but in a non-limiting way, a laser cutting machine or a CNC machine. This cutting machine can then use this file for the customised cutting out of one or more occlusion filters to dimensions adapted to the lenses of the wearer of spectacles. These occlusion filters can be, in a non-limiting way, of type Ryser, “Press-On” or self-adhesive solar films.

In a sixth variant, steps 31, 32, 33 and 34 are performed at the wearer's home. In this case, the “tracer” mentioned in the following steps of the method is to be understood as being the device described in the third variant.

In a seventh variant, steps 31, 32, 33 and 34 are performed in any other location than in the optician's premises or the wearer's home, provided this location has suitable hardware and software.

In an eighth variant, step 41 is performed automatically by a machine suitable for this specific task of attaching temples to the hinges.

In a ninth variant, steps 40 and 41 are performed in a shared manufacturing centre where the wearer can go to find his manufactured frames. Alternatively, this centre can send the manufactured frames to any place agreed to by the wearer.

In a tenth variant, steps 40 and 41 are performed at the wearer's home or in any other location available to him where he has access to a manufacturing machine compatible with this method so as to have his frames manufactured there. If the manufacture takes place outside his home, the wearer can go there to collect the frames after manufacture, or have them delivered to any location at his convenience.

As can be seen by reading the description above, the present invention makes possible the speedy and sustainable supply of replacement spectacles, compared to a makeshift repair. In the case where the old frame has been damaged, this speedy supply reduces the risks linked to potentially dangerous professional or personal activities, for example handling toxic products or operating vehicles or machines.

FIG. 6 shows a radial cross-section 61 of a rim of a frame produced by utilising the present invention and a portion of a lens 60. It shows, in particular, the counter-bevel 62 and the bezel 63. The offset is the difference between the external edge (at the bottom in FIG. 6) of the counter-bevel 62 and the inner surface (at the top in FIG. 6) of the radial cross-section 61. The radial cross-section 61 of each rim is in a plane comprising an axis parallel to the optical axis of this lens.

Two variants of the software utilised to implement the method that is the subject of the invention are described below. The file with the suffix “oma” or another format generated by the mechanical scanner normally used, and which the person skilled in the art is equipped with, is imported.

This file is analysed and two data lists are extracted to the memory of a computer: Liste_OD for the right eye and Liste_OG for the left eye. Each list comprises a series of points and each point consists of the record of the coordinates (in two or three dimensions).

A list of additional points, Liste_Section, records a predefined shape for the section of the frame. This Liste_Section can come from a storage medium of the computer utilising the software program. The advantage of defining it on an internal or external storage medium is to enable the person skilled in the art to redefine these parameters himself based on changes in the sector's best practices. In addition, it makes it possible to adjust the tolerances to the specific constraints of the material used for 3D printing. The modification of these parameters can be carried out either directly in the file, or through a user interface integrated into the main algorithm. The predefined shape is chosen based on the known dimensions by the person skilled in the art for a correct adjustment of the lenses in the bezel or the channel of the frame, as represented in the figure below:

This section is then extruded, i.e. applied, along the contour of the frame by duplication of this section and successive stacking of such sections to form each successive layer producing the 3D mesh of the frame, recorded in the memory of the computer: Maillage_Monture.

In the lists Liste_OD and Liste_OG, the points located in a predefined area on the left of the right lens and on the right of the left lens are selected, these areas being located in the upper portion of the frame.

The points selected in this way are moved along the normal to the curve at each point.

The two curve arcs formed in this way are recorded in memory in two lists: Liste_AD and Liste_AG.

A method of parametric interpolation or extrapolation, such as the Bézier method, or of splines such as the Catmull-Rom method, or the Hermite polynomial method, is used. This method makes it possible to close the curve established in the previous step to form the bridge between the two lenses.

The list of points forming the curve of the bridge Liste_Pont integrates Liste_AD and Liste_AG and adds to them the points calculated by parametric interpolation or extrapolation, and it is recorded in the computer's memory.

An extrusion along the Oz axis carried out from the layer of the bridge by successive stacking defines a 3D mesh of the bridge recorded in memory: Maillage_Pont.

For constructing the end pieces of the frame, the same principle is used as for the construction of the bridge: in a predefined area on the upper right edge of the right lens and upper left edge of the left lens, points of the curve are extracted from Liste_O and Liste_OD. These points are recorded in two new lists: Tenon_OD and Tenon_OG.

By extrusion along the Oz axis, the various stacked layers are recorded in two memory areas: Maillage_Tenon_OD and Maillage_Tenon_OG.

Predefined hinge meshes, Maillage_Charnière_OD and Maillage_Charnière_OG, are imported from a storage medium (read-only memory) of the computer or already defined in the body of the program and combined in random-access memory with the mesh of each of the end pieces.

All the meshes produced in this way-Maillage_Monture, Maillage_Pont, Maillage_Tenon_OD, Maillage_Tenon_OG, Maillage_Charnière_OD and Maillage_Charnière_OG—are then grouped in a single memory area: Maillage_Monture_Complet.

This Maillage_Monture_Complet recording is then:
either converted into a file whose format (STL or other type) is compatible with the input formats accepted by commercially available slicers, the purpose of this slicer being to transform the file in STL format into a file comprised of codes that can be interpreted by the electronics of a 3D printer (typically, but not exclusively, a g-code format);
or converted directly, in a last step of the algorithm described above, into a file comprised of codes that can be interpreted by the electronics of a 3D printer (typically, but not exclusively, a g-code format).

The software described above can be hosted by a computer in an optician's store, by a remote server, or directly in an electronic control card of a 3D printer.

A second variant of the software is described below.

Contours are imported from the .oma file, or equivalent, (fields taken into account: _FILENAME, OMAV, DBM, HBOX, VBOX, TRCFMT, R, A):
variant with only one or two contours (completed by symmetry if necessary)
reading of the list of radii
reading of the optional list of radius angles (if not, they are calculated regularly from 0 to 360°)
reading of the distance left eye centre to right eye centre
reading of the distance between the lenses
size of the lenses (hbox+vbox).

2D positions are calculated for elements of the frame, modifiable through the algorithm parameters:
width and support points of the nose (top start, top centre point, bottom start, bottom centre point)
thicknesses and extension of the end pieces
total width of the frame.

The impossible geometric constraints are detected.

Two-dimensional modelling by closed splines is carried out:
calculation of a closed spline curve based on the radial sampling of the lenses (simplification and acceleration, the error between the spline and the sampling can be adjusted)
calculation of the bridge based on a closed spline and anchor points on the left and right rims (see the diagram).

A profile is extruded along the 3D spline (“sweep” operation for a 2D shape perpendicular to a path in the space, here the support splines):
partial semi-circular profile for the nose
partial semi-circular profile (external) for the rim, and straight with a groove for the bezel (adjustable).

Pads are added along the rims (position, length, height, flare are adjustable)

Hinges are defined with an external chamfered (rounded) profile and interior barrels with adjustment angles.

A virtual assembly comprising the following is carried out:
left eye, right eye, grooving
nose (bridge)
pads
end pieces and hinges.

An export is carried out, in one of the following formats:
STL (approximation by facets)
STEP (CAD file with mathematically pure shapes)
SVG 2D (without facets)

This second variant has the following advantages compared to the first:
the absence de facets in the generated shape can result in an adjustment to the printing accuracy in the last step, the step of generating the file for 3D printing (STL file);
the generation of a mathematically pure shape is compatible with industrial CAD software systems (STEP format) and allows machining by methods other than 3D printing;
similarly, the mathematically pure shape makes it possible to present a 3D vector view (which can therefore be infinitely scalable; SVG file) of the generated frame with a view to validation by the person skilled in the art before 3D printing.

In order to highlight these last advantages, as well as the dimensions chosen in practice, here is a list of the parameters that can be modified and their default values:
stl file optional, path of the STL file to generate;
step file optional, path of a STEP file to export;
svg file optional, alternate SVG file to export to;
log file optional log file to output to (instead of stdout);
frame-thickness mm, optional thickness seen from side (Default: 3.2);
rim-offset mm, offset applied to OMA radii (Default: −0.1);
rim-precision mm, precision of OMA curve (1 mm is good) (Default: 1.0);
rim-width-mid mm, thickness of the rims seen from the front (Default: 2.4);
rim-width-outer mm, optional thickness of the top & bottom rims seen from the side (Default: 1.6);
hinge-hole-size mm, hinge hole size (consider a +0.2 mm margin) (Default: 2.65);
hinge-hole-rot deg, rotation of hinge holes on their axis (Default: 5);
hinge-pos mm, y-coordinate of hinges (Default: 8);
hinge-outwards mm, outwards displacement of the hinge (origin is the outer rim edge) (Default: 4);
hinge-thickness mm, margin around the hinge holes (Default: 2.4);
temple-height mm, temple height (sets hinge height) (Default: 6.5);
hinge-flare mm, hinge thinning (Default: 1);
hinge-edge-rounding mm, hinge edge rounding (Default: 2);
bridge-top-start mm, y-coordinate of bridge top sides (Default: 21);
bridge-top-center mm, y-coordinate of bridge top centre (Default: 11);
bridge-top-flat mm, bridge top flat width (Default: 4);
bridge-bot-start mm, y-coordinate of bridge bottom sides (Default: −9);
bridge-bot-center mm, y-coordinate of bridge bottom centre (Default: 10);
bridge-bot-flat mm, bridge bottom flat width (Default: 3);
bridge-inset mm, inset of bridge sides (0 to be tangent to the rims) (Default: 2);
rim-bezel-height mm, height of the bezel (Default: 1.8);
rim-bezel-depth mm, depth of the bezel (Default: 0.8);
pad-position mm, vertical offset of the pads on the iso line (Default: −2);
pad-length mm, length of the pads (Default: 15);
pad-depth mm, depth of the pads (Default: 4.5);
pad-thickness mm, thickness of the pads (Default: 1.8);
pad-flare-angle deg, flare angle of the pads (Default: 20);
total-width mm, optional, overrides hinge ‘outwards’ width (custom);
bridge-width mm, optional, overrides OMA dbl definition (custom);
bridge-pos mm, optional, overrides bridge vertical position (0 is centred);
box-height mm, optional, overrides OMA box height;
box-width mm, optional, overrides OMA box width.

In a variant, steps 31 to 34 of the patent are replaced by the generation of a contours description file directly by means of a 3D design software system (e.g. Maya, Catia, Solidworks, etc.) that was used for the initial 3D design by the manufacturer. A manufacturer of frames can therefore make files defining the 3D designs of frames available in a library. This library can be accessible by means of a remote server and interrogated by the software program utilised by the device that is the subject of the invention to retrieve the contour file corresponding to the frame and allowing it to generate a 3D replacement frame.

The tolerances and dimensions for the radial cross-section of the rim of the frame (including the bezel) can be taken into account through a recording this information on a storage medium. Alternatively, a user interface (HMI) allows them to be defined.

The “frame-thickness” is the thickness in millimetres of the frame in side view. The default value is chosen to take into account the rigidity and elasticity of the material. The frame is thin enough that it can be printed rapidly, but rigid enough that the fame can hold the lenses sufficiently well.

With regard to the following variables:
rim-offset mm, offset applied to OMA radii (Default: −0.1);
rim-precision mm, precision of OMA curve (1 mm is good) (Default: 1.0);
rim-width-mid mm, thickness of the rims seen from the front (Default: 2.4);
rim-width-outer mm, optional thickness of the top & bottom rims seen from the side (Default: 1.6).

The adjustments of the rims here correspond to the view of the frame in front view.

The thickness rim-width-mid, here 2.4 mm, is chosen to allow the lenses to be clipped in cold. A frame that is too thick is unattractive, and makes it too difficult to insert the lens. Conversely, a frame that is too thin tends to break during the installation of the lenses.

With regard to the variables:
hinge-hole-size mm, hinge hole size (consider a +0.2 mm margin) (Default: 2.65);
hinge-hole-rot deg, rotation of hinge holes on their axis (Default: 5);
hinge-pos mm, y-coordinate of hinges (Default: 8);
hinge-outwards mm, outwards displacement of the hinge (origin is the outer rim edge) (Default: 4);
hinge-thickness mm, margin around the hinge holes (Default: 2.4)
they relate to the configuration of the hole that has to receive the metal hinge, itself selected for reasons of robustness and commercial availability.

The size of the hole makes it possible to receive the snap-in insertion of the hinge. This is done without heating the material. With these parameter values, the hinges remain “embedded” once installed without using a screw or glue to hold them in the frame. A cold “clip-in” into the frame is obtained.

The rotation of five degrees is chosen here to allow the temples to be superimposed once folded. This is a parameter that depends on the model of hinge used. This default value was selected after a number of printing trials.

For the position (in terms of height) of the end piece in front view where the hinge hole is located, the value is chosen for mainly aesthetic reasons. Eight mm corresponds to the height from the iso boxing reference.

The distance between the rim and the hole (4 mm) is a default setting for obtaining sufficient resilience during the tensioning of the surface when the temples are engaged when opening the temples and placing on the wearer's face. A higher value accentuates a lever effect that deforms the surface too much (this is due to the flexibility of the material used). A lower value induces an overall narrowness of the frame that no longer allows the surface to fit properly on the customer's face (moving away from the initial width of the frame initially scanned, which has on average end pieces closer to 6-7 mm on average).

The margin of material surrounding the hole is set by default to 2.4 mm to allow the hinge to be adequately supported so as to again boost cold embedding here for it to be held firmly in the surface.

With regard to the variables:
temple-height mm, temple height (sets hinge height) (Default: 6.5);
Position of the bottom part of the end piece resulting from other settings
hinge-flare mm, hinge thinning (Default: 1);
hinge-edge-rounding mm
hinge edge rounding (Default: 2);
these values correspond to the rounding of the end piece in front view, the result of an aesthetic choice.

With regard to the variables:
bridge-top-start mm
y-coordinate of bridge top sides (Default: 21)
bridge-top-center mm
y-coordinate of bridge top centre (Default: 11)
bridge-top-flat mm, bridge top flat width (Default: 4)
bridge-bot-start mm
y-coordinate of bridge bottom sides (Default: −9)
bridge-bot-center mm
y-coordinate of bridge bottom centre (Default: 10)
bridge-bot-flat mm, bridge bottom flat width (Default: 3)
bridge-inset mm, inset of bridge sides (0 to be tangent to the rims) (Default: 2)

All the values are chosen so that the bridge always has a sufficiently solid structure to contain the deformation induced by opening the temples and placing the frame on the face.

The settings make it possible to take into consideration the multiple scenarios linked to two variables that introduce 3D model generation constraints, which are the distance between the two lenses and the shape of the lenses.

With regard to the variables:
rim-bezel-height mm
bezel height (Default: 1.8);
rim-bezel-depth mm, depth of the bezel (Default: 0.8);
pad-position mm, vertical offset of the pads on the iso line (Default: −2);
pad-length mm, length of the pads (Default: 15);
pad-depth mm, depth of the pads (Default: 4.5);
pad-thickness mm, thickness of the pads (Default: 1.8);
pad-flare-angle deg
flare angle of the pads (Default: 20)
the position of the pads is set here to not conflict with the position of the bridge. The thickness of the pads is set here to 1.8 mm to not go beyond the profile in front view of the thickness of the frame (2.4 mm). The other parameter values are chosen after several prints in order to obtain a comfortable seating. The relationships between the values of these parameters are in a table of correspondence between pads based on the type of nose or frame detailed in the previous document.

The criteria governing the filling of this correspondence table may comprise, for example:
a smaller lens corresponds to a larger offset, to compensate for the reduced flexibility of the frame, for an identical radial cross-section;
a lens with a more rectangular shape factor corresponds to a larger offset, to compensate for the curvature of the contour, for an identical radial cross-section;
a lens with a more rectangular shape factor corresponds to a smaller radial cross-section, to increase the flexibility in flexion of the contour of the lens.

An example of the table of correspondence between offsets in relation to the scanned shape is given below.

| | Circular shape frame | Rectangular shape frame |
|---|---|---|
| Metal frame with the pads | Algo 1 pad | Algo 2 pad |
| set loose on the nose | Front view: curved and thin | Front view: rectilinear and |
| Or | (thickness in the extension of the | thin |
| Acetate frame with the nose | thickness of the frame) | (thickness in the extension of |
| shape aimed at a “Western” | Flare angle slightly open (115°) | the thickness of the frame) |
| nose type | Side view: not very deep (4 mm) | Flare angle slightly open |
| | | (115°) |
| | | Side view: not very deep |
| | | (4 mm) |
| Metal frame with the pads | Algo 3 pads | Algo 4 pads |
| set tight on the nose | Front view: curved and thick | Front view: rectilinear and |
| Or | (+2 mm/thickness frame) | thick (+2 mm/thickness |
| Acetate frame with the nose | (extension of excess thickness | frame) |
| shape aimed at an “Asiatic” | nose side in front view) | (extension of excess |
| nose type | Flare angle very open (145°) | thickness nose side in front |
| | Side view: deep (+8 mm) | view) |
| | | Flare angle very open (145°) |
| | | Side view: deep (+8 mm) |
| | Shape more CIRCULAR | Shape more RECTANGULAR |
| Shape scanned from the lens | Offset +0.30 mm | Offset +0.45 mm |
| Shape scanned from the frame | Offset +0 mm | Offset +0.15 mm |

An example of the table of correspondence between offsets in relation to the strength of the lenses is given below:

| | Strength | −6D | +6D |
|---|---|---|---|
| Bevel, rear surface | +0.15 mm | +0.02 mm | +0.05 mm |
| Bevel 50/50 | +0.10 mm | +0.05 mm | +0.10 mm |
| Bevel, front surface | +0.05 mm | +0.00 mm | +0.15 mm |

It is noted that these correspondence tables may forbid certain colours (which correspond to lower elasticities before breakage) for certain combinations of radial cross-section, lens shape, curvature of the lens, etc.

An example of the table of correspondence is given below for the geometry of the plates in relation to the shape factor of the lens and therefore of the frame.

An example of the relationship between the curved shape of the lens, which can be steep in the case of sunglasses, and can affect the tolerance to be added to the contour of the lens for defining the contour.

A table is given below of the correspondence between the curved shape of the lens and the tolerance to be added to the contour of the lens for defining the inner contour of the frame and compensate for the curvature.

| | Shape offset setting |
|---|---|
| Frame curve 4 | +0.15 mm |
| Frame curve 6 | +0.25 mm |
| Frame curve 8 | +0.35 mm |

1. A device for manufacturing a frame of a pair of spectacles from at least one lens to be inserted therein, such that said frame is adapted to the shape and dimensions of the lenses, which device is characterised in that it comprises:
a scanner configured to represent, in at least two dimensions, a contour of at least one lens and supply a file comprising information representative of this contour;
a means for computing the frame of a pair of spectacles suitable for receiving and holding each lens, on the basis of the representation of each lens contour; and
a means for controlling a machine for manufacturing the computed frame.

2. The device according to claim 1, which also comprises a machine for manufacture by additive printing of successive layers, the printing material being a flexible material and the computing means being configured such that the entire surface of the frame surrounding the lenses is printed as of the first printed layer.

3. The device according to claim 2, wherein the computing means is configured to ensure compliance with a predefined criterion among:
the curvature of each rim surrounding a lens intended to go into this rim and in a plane tangential to the lens, and comprising an axis parallel to the optical axis of this lens;
the radial cross-section of each rim, in a plane perpendicular to this plane tangential to the lens and comprising an axis parallel to the optical axis of the lens; and
the elasticity limit of the printing material.

4. The device according to claim 2, wherein the computing means is configured to define each rim as a function of the curvature of each lens intended to go into this rim and in a plane tangential to the lens, and comprising an axis parallel to the optical axis of this lens.

5. The device according to claim 4, wherein the computing means is configured to estimate this curvature of the lens based on a shape factor of the lens and a curved shape of the lens.

6. The device according to claim 1, wherein the scanner is configured to represent, in two dimensions, the contour of each lens and supply a file comprising information representative of this contour in two dimensions.

7. The device according to claim 1, wherein the scanner is configured to represent the contour of a counter-bevel formed on the contour of the lens, and the computing means is configured to:
make a deduction for a portion of an estimate of the difference between this contour of the counter-bevel and the contour of the lens outside this counter-bevel,
define rims with a bezel corresponding to this counter-bevel.

8. The device according to claim 1, which comprises the additive layer manufacturing machine, the computing means being configured such that the bezel is formed uniformly in the same successive layers for the whole of the rim of the frame surrounding this lens.

9. The device according to claim 1, wherein the computing means is configured to form a counter-bevel turned towards the lens in at least one rim of the frame.

10. The device according to claim 1, wherein the computing means is configured to produce two different rims for lenses with different contours.

11. The device according to claim 1, wherein the computing means is configured to form a rim around each lens, with one portion taken away from the contour of the lens at the bridge between the lenses, this bridge thus having two side pieces on each lens.

12. The device according to claim 2, which comprises the manufacturing machine, wherein the manufacturing machine produces the frame using a bio-based, biodegradable and/or recyclable material.

13. The device according to claim 1, which comprises a slicer between the control means and the manufacturing machine.

14. The device according to claim 1, wherein the scanner is configured to represent, in at least two dimensions, a contour of a lens, at least one direction of which is referenced, and the computing means is configured to receive a measurement of the distance between the lenses, determine the shape of a second lens of the pair of spectacles by symmetry with the lens scanned, and provide the control means with a representation of the two lenses separated by the distance measured.

15. The device according to claim 1, wherein the computing means is configured to determine the rims surrounding the lenses incorporating bezels corresponding to the counter-bevels of the lens and a bridge shape between the rims.

16. The device according to claim 1, wherein the computing means is configured to determine an end piece shape for supporting a temple hinge and shapes of temples to be attached to the hinges of the end pieces.

17. The device according to claim 1, wherein the computing means is configured to determine the colour or distribution of colours of the frame.

18. A method for manufacturing a frame of a pair of spectacles from at least one lens to be inserted therein, such that said frame is adapted to the shape and dimensions of the lenses, which method is characterised in that it comprises:
a step of scanning to obtain a representation, in at least two dimensions, of a contour of at least one lens by means of a file comprising information representative of the contour;
a step of computing the frame of a pair of spectacles on the basis of the representation of the contour of each lens; and
a step of controlling a machine for manufacturing the computed frame.
